(19) United States
(12) Patent Application Publication
(10) Pub. No.: US 2025/0044472 A1
(43) Pub. Date: Feb. 6, 2025

(54) SOURCE SEPARATION USING MULTISTAGE INVERSION WITH RADON IN THE SHOT DOMAIN

(71) Applicant: Schlumberger Technology Corporation, Sugar Land, TX (US)

(72) Inventors: Yousif Izzeldin Kamil Amin, Dhahran (SA); Rajiv Kumar, Gatwick (GB); Massimiliano Vassallo, Gatwick (GB)

(21) Appl. No.: 18/714,924

(22) PCT Filed: Jan. 13, 2023
(86) PCT No.: PCT/US2023/060614

§ 371 Date: May 30, 2024

Related U.S. Application Data
(60) Provisional application No. 63/299,182, filed on Jan. 13, 2022.

(51) Int. Cl. G01V 1/36; G01V 1/28; G01V 1/32

(52) U.S. Cl. CPC G01V 1/364; G01V 1/282; G01V 1/325; G01V 2210/127; G01V 2210/3248; G01V 2210/46; G01V 2210/614

(57) ABSTRACT

A method for processing seismic data includes receiving blended seismic data from one or more seismic sources. The method also includes applying a transform to the blended seismic data to decompose the blended seismic data into different parameters. The method also includes applying one or more independent sparse inversions to the different parameters. The method also includes defining a set of prior information techniques to be used within the one or more independent sparse inversions. The method also includes determining an energy part of the blended seismic data that is greater than a first predetermined threshold based at least partially upon the multiple independent sparse inversions, the set of prior information techniques, or both. The method also includes removing the energy part from the blended seismic data to produce modified seismic data.

This application claims priority to U.S. Provisional Patent Application No. 63/299,182, filed on Jan. 13, 2022, the entirety of which is incorporated by reference herein.

### BACKGROUND

Sparsity-promoting source separation technologies remove source interference or crosstalk among shots. This is known as blending noise in simultaneous source acquisition, where multiple sources on multiple vessels are firing at the same time with time delays. The underlying idea is to find a transform domain where the coherent seismic signal of interest is sparse while interference noise is smeared and uniformly distributed in time and space. Imposing sparsity constraints regularizes the inverse problem to perform stable source separation.

A multi-stage iterative source separation with priors framework may be used for source separation to progressively model the source separated signal while eliminating the interference in a signal safe manner. This method adopts a multi-stage strategy where different sparsity promoting prior information is utilized to optimize the signal-to-noise ratio (SNR) at each stage. In each stage, the algorithm focuses on separating different modes of seismic signal starting with the strongest signal. Results on real data showed that the combination of the multi-stage strategy and the sparsity promoting priors provides better source separation performance compared to conventional inversion methods.

While the multi-stage strategy stabilizes the source separation, the computational cost of applying the separation framework to large-scale seismic data volumes is large. More particularly, the computational cost for multi-stage depends upon the cost of N-dimensional transform domain to impose the sparsity constraints. As users move away from 2-dimensional transform domain to 3- and 5-dimensions, the computational bottleneck subdues the benefits of using the multistage source separation framework for any acquisition environment.

### SUMMARY

Embodiments of the present disclosure may provide a method for processing (e.g., deblending) seismic data. The method includes receiving blended seismic data from one or more seismic sources. The method also includes applying a transform to the blended seismic data to decompose the blended seismic data into different parameters. The method also includes applying one or more independent sparse inversions to the different parameters. The method also includes defining a set of prior information techniques to be used within the one or more independent sparse inversions. The method also includes determining an energy part of the blended seismic data that is greater than a first predetermined threshold based at least partially upon the multiple independent sparse inversions, the set of prior information techniques, or both. The method also includes removing the energy part from the blended seismic data to produce modified seismic data.

Embodiments may also include a computing system. The computing system includes one or more processors and a memory system. The memory system includes one or more non-transitory computer-readable media storing instructions that, when executed by at least one of the one or more processors, cause the computing system to perform operations. The operations may include receiving blended seismic data from a plurality of seismic sources. The blended seismic data include pressure measurements, particle motion measurements, or both. The operations also include applying a transform to the blended seismic data to decompose the blended seismic data into different parameters. The parameters include directions, dips, slownesses, or a combination thereof. The operations also include applying multiple independent sparse inversions to the different parameters. The operations also include defining a set of prior information techniques to be used within the multiple independent sparse inversions. The set of prior information techniques is configured to enhance a sparsity of a mode of a signal of interest in the blended seismic data at the different parameters. The operations also include determining an energy part of the blended seismic data that is greater than a first predetermined threshold based at least partially upon the multiple independent sparse inversions and the set of prior information techniques. The operations also include predicting an interference of the blended seismic data based at least partially upon the energy part. The operations also include removing the energy part and the interference from the blended seismic data to produce modified seismic data.

Embodiments may also include a non-transitory computer-readable medium storing instructions that, when executed by at least one processor of a computing system, cause the computing system to perform operations. The operations may include receiving blended seismic data from a plurality of seismic sources. The blended seismic data includes pressure measurements and particle motion measurements. The operations also include applying a transform to the blended seismic data to decompose the blended seismic data into different directions, dips, and slownesses. The operations also include applying multiple independent sparse inversions to the different directions, dips, and slownesses. The operations also include defining a set of prior information techniques to be used within the multiple independent sparse inversions. The set of prior information techniques is configured to enhance a sparsity of a mode of a signal of interest in the blended seismic data at the different directions, dips, and slownesses. The set of prior information techniques causes interference in the blended seismic data to become more incoherent. The operations also include determining an energy part of the blended seismic data that is greater than a first predetermined threshold based at least partially upon the multiple independent sparse inversions and the set of prior information techniques. The multiple independent sparse inversions stop based at least partially upon a value of the energy part. The operations also include predicting an interference of the blended seismic data based at least partially upon the energy part. The operations also include removing the energy part and the interference from the blended seismic data to produce modified seismic data. The operations also include displaying the modified seismic data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a schematic view of one or more shots and one or more channel gathers, according to an embodiment.

FIG. 5 illustrates a schematic view of the shot being transformed into a shot and then into slowness before deblending, according to an embodiment.

FIG. 6 illustrates a flowchart of a method for deblending seismic data, according to an embodiment.

FIG. 7 illustrates a computing system for performing at least a portion of the method(s) disclosed herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of embodiments of the invention. However, it will be apparent to one of ordinary skill in the art that embodiments of the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the embodiments of the invention. The first object and the second object are both objects, respectively, but they are not to be considered the same object.

The terminology used in the description herein is for the purpose of describing particular embodiments only and is not intended to be limiting of the invention. As used in the description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

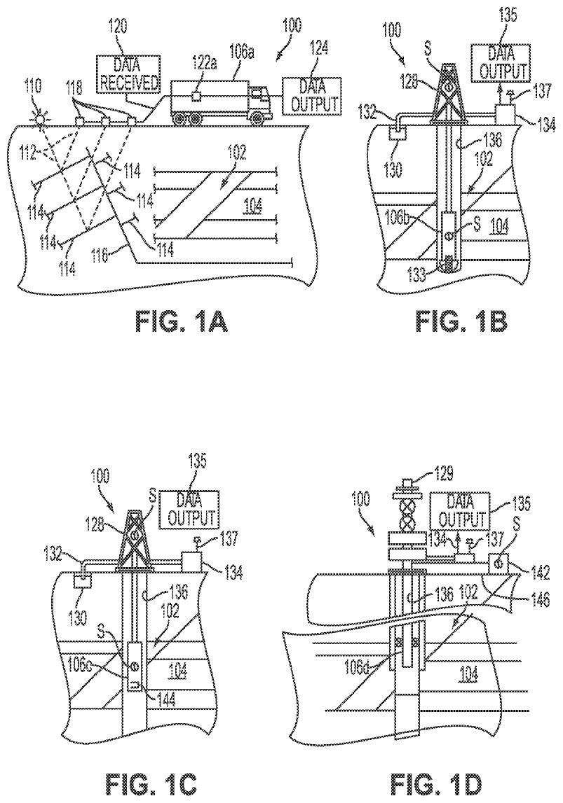

FIGS. 1A-1D illustrate simplified, schematic views of oilfield 100 having subterranean formation 102 containing reservoir 104 therein in accordance with implementations of various technologies and techniques described herein. Although embodiments of the present method are at least partially described herein with reference to an oilfield, it will be appreciated that this is merely an illustrative example. Embodiments of the present method may be employed in any application in which visualizing, modeling, or otherwise identifying subsurface features (e.g., geological features) may be useful. Examples outside of the oilfield context include subsurface mapping for wind arrays and/or solar arrays, geothermal energy production, mining operations, offshore/deep ocean applications, etc.

FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors(S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

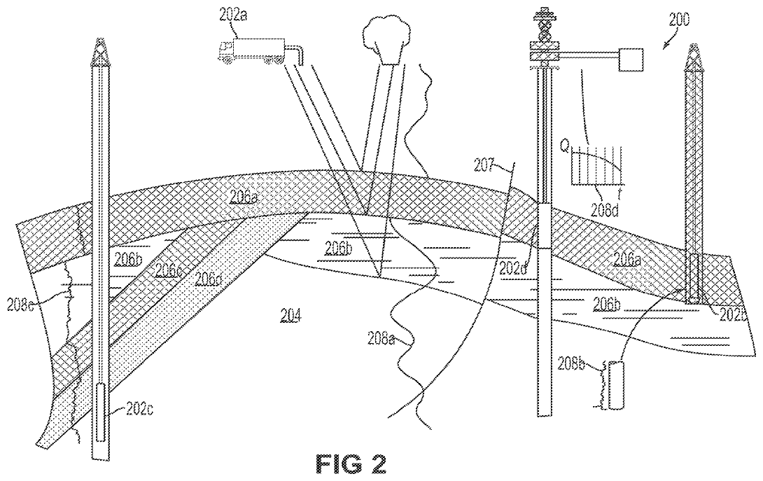

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

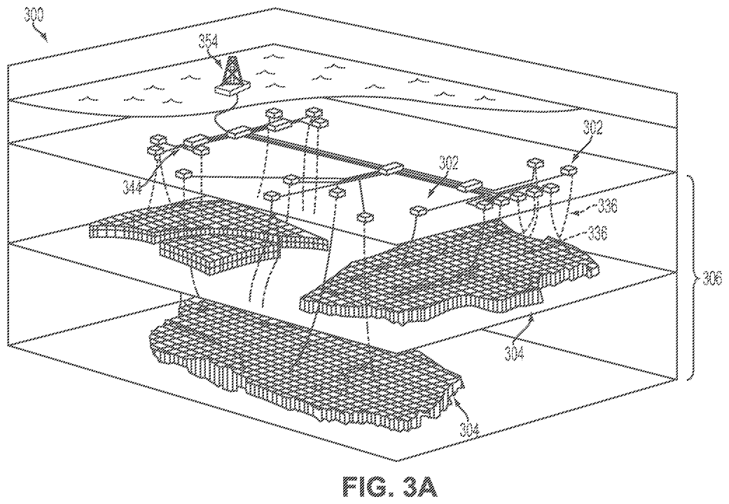

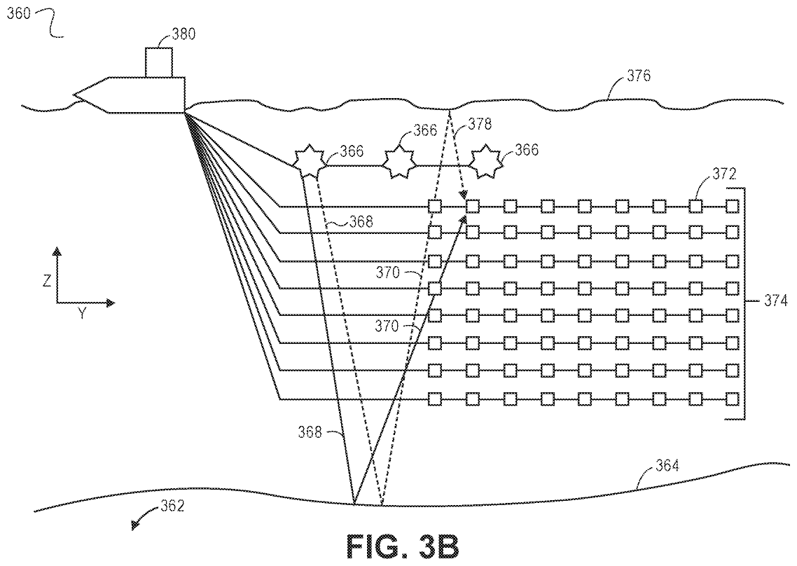

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Source Separation Using Multistage Inversion with Radon in the Shot Domain

A source separation problem can be described using the following linear form:

$$b = Γ u + n , \qquad ( 1 )$$

where b∈ [symbol] ⁿ^{_{tb}}ⁿ^{ᵣ}^{×1}, denotes the observed blended data in continuous form, which contains the signals recorded at nᵣ receivers within n_{tb} time samples. The variable Γ∈ [symbol] ⁿ^{_{tb}}ⁿ^{ᵣ}^{×n}^{ₜ}ⁿ^{ₛ}ⁿ^{ᵣ} denotes the blending operator containing the timing information that describe the overlap of nₛ sources. The variable n∈ [symbol] ⁿ^{_{tb}}ⁿ^{ᵣ}^{×1} is the background noise, which may contain any signal that is not captured by the blending operation (e.g., non-cooperative interference). The system and method described herein may recover u∈ [symbol] ⁿ^{ₜ}ⁿ^{ₛ}ⁿ^{ᵣ}^{×1} denoting the unblended data (e.g., each trace has nₜ samples) in vector form that would have been recorded if there were no overlap in the sources. In equation (1), n_{tb}<nₜnₛ, which indicates that this is ill-posed and has infinitely many solutions. Consequently, this problem involves some sort of regularization (or prior information, in Bayesian inference terms). One way to regularize the problem of estimating u, given b, includes a constrained optimization problem of the form:

$${min}_{u} {‖ 𝒮 u ‖}_{1} \qquad ( 2 )$$

$$subject to$$

$$\frac{1}{2} {‖ b - Γu ‖}_{2}^{2} \leq ϵ ,$$

where ∥r∥₁ is [symbol] ₁ norm of the vector r defined as the sum of the absolute values of its elements, ∈ is the parameter which depends upon the noise variance, and [symbol] is the analysis sparsity-promoting transform domain. For solving problems of this form, the algorithm(s) may belong to the iterative shrinkage/thresholding (IST) family. The system and method described herein adopt fast iterative soft thresholding algorithm (FISTA), where at each iteration, the estimated deblended vector û may be updated as follows:

$${\hat{u}}_{i} = {𝒮}^{H} ( {ζ}_{λ ( {α}_{i} )} ( 𝒮 ( {\hat{u}}_{i - 1} + {α}_{i} {Γ}^{T} ( b - Γ {\hat{u}}_{i - 1} ) ) ) ) \qquad ( 3 )$$

where ζ used is the exponential shrinkage operator, αᵢ, λ are the step-length and thresholding values, and the symbol (·)^{H}, (·)^{T} represents the matrix conjugate transpose and transpose, respectively.

### Priors Based Source Separation

From the constrained optimisation in equation (2), the robustness of the source separation algorithm rests upon finding suitable sparsity promoting domain to represent the desired unblended data u. The search for a sparsity-promoting domain adapted to the signals may be difficult. This can become particularly relevant in challenging simultaneous source acquisition scenarios where the energy of the interference is orders of magnitude stronger than the desired reflected energy causing inevitable degradation in the sparse inversion performance. Therefore, instead of assuming that the unblended signal is naturally sparse in the sparsity-promoting domain, various suits of prior information may be imposed to enhance the sparsity of the data. As such the constrained minimization in equation (2) can be written as:

$${min}_{u} {\sum }_{n = 1}^{N} {η}_{n} {‖ {𝒮𝒫}_{n} u ‖}_{1} \qquad ( 4 )$$

$$subject to$$

$$\frac{1}{2} {‖ b - Γu ‖}_{2}^{2} \leq ϵ ,$$

where { [symbol] ₙ}ₙ₌₁^{N} encompass various suits of prior information that enhance the sparsity of the signal in the transformed domain [symbol] , and ηₙ is the parameter balancing the different sparsity-promoting priors. One example of prior information that can be incorporated is moveout correction. Moveout correction can be used to reduce the curvature of seismic events and enforce sparsity in the transform domain while the interference noise remains uncorrelated. Applying moveout correction with different velocities can improve the sparsity of these events in these domains and make it easier to distinguish the signal from the background noise. To solve equation (4), a simple N-stages strategy may be adopted, where in each stage (say j), the system iteratively solves for a specific signal mode and ignores the other less energetic modes (i.e., ηⱼ=1; ηₙ=0, ∀n≠j). To be able to improve the coherency in that mode and remove the associate interference, an appropriate moveout correction [symbol] ⱼ may be applied to flatten associated mode events. The estimated deblended data û can be updated in each iteration in the jth stage as:

$${\hat{u}}_{i}^{j} = {𝒫}_{j}^{†} {𝒮}^{H} ( {ζ}_{λ ( {α}_{i} )} ( 𝒮 {𝒫}_{j} ( {\hat{u}}_{i - 1}^{j} + {α}_{i} {Γ}^{T} ( {b}^{j - 1} - Γ {\hat{u}}_{i - 1} ) ) ) ) , \qquad ( 5 )$$

where [symbol] ⱼ, [symbol] ⱼ^{†} denote the forward and inverse moveout correction. After each stage, the estimated deblended data û^{j} is blended and subtracted from the residual of the previous stage b^{j-1}:

$${b}^{j} = {b}^{j - 1} - Γ {\hat{u}}^{j} \qquad ( 6 )$$

This process makes the inversion more favorable for weaker events and improves the quality of the source separation. An arbitrary number of stages with different moveout corrections targeting different signal modes may be used to improve the deblending performance. Examples include direct arrival, ground roll, shear noise, reflection and refraction events, etc. In the ocean bottom node (OBN) scenario outlined in the example below, a three-stage strategy is implemented. In the first stage, a linear moveout (LMO) correction is used to enhance the sparsity of the direct arrival signal û¹ and remove the associated interference. In the second stage, normal moveout correction (NMO) is applied to reduce the curvature of the reflection and refraction events and hence improve their estimation û². This is followed by the final stage where no moveout correction is used to deal with weaker seismic events that does not obey any apriori known moveout characteristics, such as diffraction energy û³. Because the moveout characteristics of the signal at the first two stages are known, the ∈ value can be derived to automatically find the stopping criteria in intermediate stages while solving equation (4). The final deblending estimate can be obtained by summing all the û^{j} estimates.

### Dimensionality

While the inclusion of the multiple stages with prior in the deblending framework may help make the weak and the strong coherent signal buried beneath the strong interference noise sparser in the transform domain, the multidimensional nature of the transform domain can play a role in source separation performance. This is because the primary signal is inherently sparser in higher dimensions. As such, if the sampling is sufficiently dense, using more dimensions can help the deblending performance. Thus, the system and method described herein may use higher dimensional transform in [symbol] in equation (2) improving the deblending performance in 3D land and OBN acquisitions. This can also help if there is poor randomness in the dither as higher dimensions have less chance of having spurious regularity in the blending noise.

Most marine towed-streamer acquisitions are poorly sampled in the crossline direction. To address this issue, the algorithm may use an extra dimension to process several consecutive common-channel gathers together and discriminate between interfering events using their dipping information relative to receivers. Interfering events that have different dip information can be isolated reducing the interference level and resulting in good deblending performance. This regards the coherence in both channel and shot directions. When arrivals from different sources have conflicting dips, the extra channel dimension may partially separate these events according to their slopes and hence improve the SBNR.

The present disclosure projects the input blended seismic data from high-dimensional volumes to a low-dimensional representation followed by performing the source separation in the low-dimensional space. The motivation comes from the fact that the coherent seismic data is composed of different wavenumbers or ray parameters, which if separated and processed independently, may produce the same results as if processed jointly. Using this insight about the seismic data, the idea is as follows: (i) first transform the blended common shot gathers in a sparsity promoting domain, where common shot gather contains the coherent energy from both the primary and interfering shots. Radon transform may be used as a transform domain to map the input blended data. However, the same analysis is true for any other sparsity-promoting domain. (ii) The multi-stage is then performed with priors source separation on individual common ray-parameter gathers. (iii) Once the deblending is performed over the common ray-parameter gathers, an inverse radon transform may be applied to map the deblended data back to the physical domain. This may reduce one of the dimensions of the problem and save the computational and memory cost of the deblending approach. The deblending can be applied to energetic slownesses to reduce the computational complexity. The linear moveout (e.g., constant delay) can be applied to the shot domain to reduce curvature. High resolution tau-p transform can be used in the shot domain to improve the deblending quality. This high-resolution transform can help isolate primary and interference events that have close dips and hence can improve the deblending quality further. This may occur near the offset. In addition, the reduced memory footprint can enable the use of higher dimensions transforms within the multistage prior based deblending algorithm. Finally, the proposed approach is not limited to marine acquisition but can be applied to any acquisition where the receivers are finely sampled.

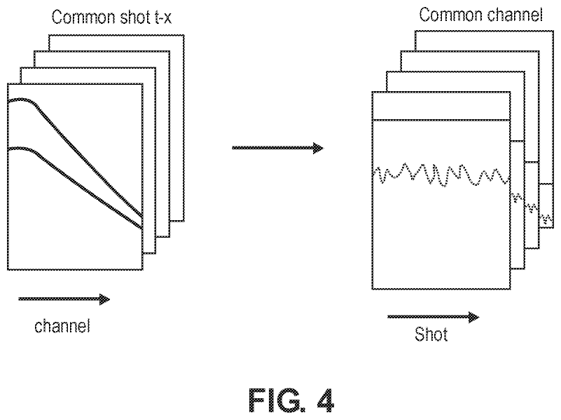

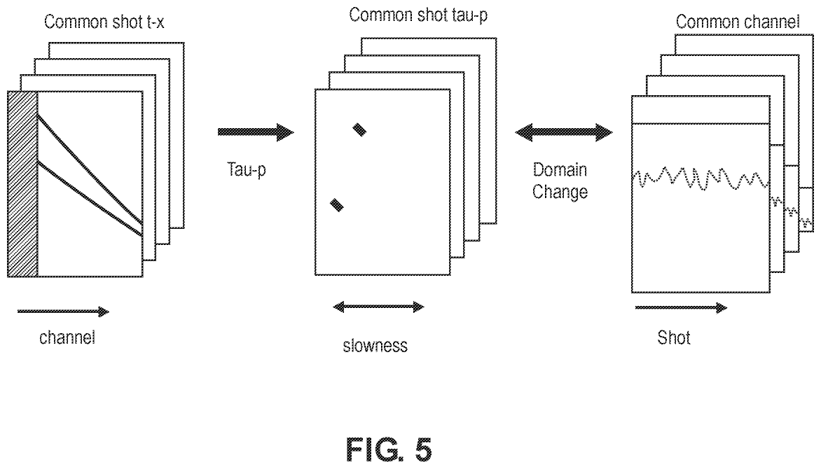

FIG. 4 illustrates a schematic view of one or more shots and one or more channel gathers, according to an embodiment. FIG. 5 illustrates a schematic view of the shot being transformed into a shot τp and then into slowness before deblending, according to an embodiment.

The present disclosure uses a multidimension multistage prior-based source separation technique that progressively models the deblended signal while eliminating the interference in a signal safe manner. In this approach, the input blended seismic data may be first projected from high-dimensional volumes to a low-dimensional representation followed by performing the source separation in the low-dimensional space. The motivation comes from the fact that the coherent seismic data includes different wavenumbers or ray parameters, which if separated and processed independently may produce the same results as if processed jointly. This can happen by transforming the data where the primary and interference is coherent using a transform that decomposes the signal into different directions or ray parameters or dips (e.g., using radon transform). Then, a multistage prior based source separation technique may be applied to the common direction/dip/slowness gather. Thus, this approach enables the algorithm to work on less data and reduce the memory footprint. The transform can be high resolution transform to enable proper isolation of interfering events with close directions.

During the acquisition design and processing, the aspects that may disturb the ability of inversion algorithms may be evaluated while distinguishing between the primary signal and blending noise in the auxiliary domain. There are several reasons that can degrade the SBNR at the auxiliary domain including an increased number of sources shooting at any point in time. Several challenges in land, marine towed-streamer, and OBN that reduce the SBNR are described below.

### Blending Noise Poor Randomness

The interference overlying the primary signal may suffer from poor randomness which can result in spurious coherency and higher noise strength in the transformed domain. Because what is relevant for deblending is the SBNR at the transformed domain, this spurious coherency can severely affect the deblending quality. In land acquisition, the natural time variations are large ensuring sufficient randomness. On the other hand, in marine towed-streamer and OBN surveys, shooting on position generates limited natural randomness in the source times. This may be due to the practical limitation of the vessels' speed variation, which in turn limits the natural randomness, resulting in occasional local coherence and hence poor deblending quality especially the low frequency. This can be an issue especially when deblending sources shooting within the same vessel. The quality of the deblending can be noticeably improved by adding random dithers to the natural randomness of shooting on position. As such, the acquisition dither range plays a role in the performance of sparse inversion deblending algorithms.

### Primary Signal Spread

Spread is the opposite of sparsity, and there are several factors that can increase the primary signal spread in the transformed domain. For example, curved events can present problems for deblending that use Fourier and linear Radon sparsity promoting domains. In those domains, curved events have less sparsity than linear events, as the energy spreads out reducing the primary signal level and hence the SBNR. Depending on the curvature of the events and the level of blending noise, the deblending performance can deteriorate considerably. This is especially true at near-offsets and in particular shallow-water acquisitions. The effect of curved events is compounded in presence of aliasing if the data is poorly sampled. This can create a challenge for sparse inversion algorithms.

In land, rapid changes in shallow velocities and elevation may produce local time delays, known as statics, that affect adjacent seismic traces, reducing and sometimes destroying the data coherency. In marine seismic, static problems exist, though to a lesser extent, in areas where there are shallow anomalies.

Finally, large and rapid irregularities in the lateral source and receiver positions can also result in noticeable incoherency in primary signal and spread in the auxiliary domain. This can visibly degrade the deblending performance.

### Dynamic Range and Shooting Patterns

The combination of high blending noise interference with low primary signal in the transformed domain can degrade the deblending algorithm performance. This can be due to one or more of the challenges mentioned above. In many acquisitions, due to unfavourable shooting patterns, the dynamic range between the interference and the primary signal can be high. For example, the interference from direct arrival events can be several thousand times higher than energy from weak reflectors. In land, surface waves are orders of magnitude stronger than the reflected energy. In many cases, weak primary signals such as reflection or diving energy from the much stronger noise may be recovered. Sparse inversion algorithms can handle this issue if it occurs sporadically. However, the combination of the high dynamic range and poor randomness can affect the deblending quality. In towed-streamer and OBN surveys, the time period between shots plays a role in this phenomenon. Shooting with natural dither and long average time period (i.e., flip-flop) is a tough source separation problem due to the presence of strong interference on weak signal.

### Background Noise

Seismic data can be contaminated by various types of background noise. In particular, any noise that does not exhibit coherency in any part of the input data can affect the deblending quality. It can be ambient noise or source generated noise (e.g., near offset vibration noise in land). It includes also seismic interference from the same or nearby surveys where the timing information is absent (e.g., non-cooperative interference, missing shot information). The noise interferes with the blending noise and the primary signal and makes it harder for any inversion algorithm to differentiate between the coherent signal and the interference noise in the sparsity-promoting domain. The deblending process may be limited by the signal-to-noise ratio in the data. As the background noise increases, the conversion speed of the deblending inversion process slows, and it may cause several complications in deblending.

The primary signal is inherently sparser in higher dimensions. Thus, the higher dimensional transform may be used to improve the deblending performance in 3D land and OBN acquisitions. This can also help in poor randomness, high dynamic range scenarios, and increased background noise. For example, in marine acquisitions, the algorithm may use an extra dimension to process several consecutive common-channel gathers together and discriminate between interfering events using their dipping information relative to receivers. Interfering events that have different dip information can be isolated reducing the interference level and resulting in good deblending performance. This regards the coherence in both channel and shot directions. When arrivals from different sources have conflicting dips, the extra channel dimension may partially separate these events according to their slopes and hence improve the SBNR. Thus, a transform may be applied that transforms the data into different dips upfront. This can enable deblending at higher dimensions and further improve the signal to blending noise ratio. It can also help isolate the events using high resolutions transform where conventional transforms may not be able to. Afterwards, the multistage prior based technique may be applied to reduced dimensions data achieving better quality deblending.

The foregoing approach can be used in a wide range of acquisition scenarios where the transform can be applied to the data in a domain where the primary and interference is coherent (i.e., common shot domains where receivers are closely spaced). The high resolution transform may be combined with applying prior within each stage of the multistage deblending process to improve the source separation capabilities and enable source separation at higher number of dimensions which can result in superior quality.

The source separation may be used in high-dimensional transform (more than 2D, i.e., 3D or 5D) domains which may reduce computation and memory. This results in better protection of seismic signals, especially the weak signal buried beneath the strong interference noise over the full spectrum of interest, as exploiting sparse structure in higher dimensions (3D or 5D) may make signal appears sparser and distinguishable as compared to the interference noise, which get uniformly distributed as we go to higher dimensions.

The source separation framework may be performed in low-dimensional space by mapping the input data into common wavenumber/ray-parameter domain. Conventional source separation technologies in the market are more computationally expensive when performing source separation in 3- and 5-dimensional space. Thus, the foregoing may provide a cost-efficient solution without compromising the quality of deblending. The benefits of the high-dimensional transform domain during deblending may be experienced without worrying about the computational and memory cost while improving the source separation both qualitatively and quantitatively.

As mentioned above, the present disclosure includes a prior based sparsity promoting multistage inversion method for deblending seismic data.
a. This may include simultaneously acquiring blended seismic data from a plurality of seismic sources.
b. One or more sets of prior information techniques may be defined based on the nature of strongest component of the seismic wavefields.
c. A transform may be applied to the data to decompose the data into different directions/dips/slownesses.
d. The transform can be a high resolution transform.
e. The sparse inversion may be applied to the common direction/dip/slowness obtained from the transform.
f. The sparse inversion may be used to estimate the strongest energy part using the above set of priors at each iteration of the inversion. The inversion stops when the strongest energy is explained.
g The estimated part may be used to predict the interference.
h The estimated part and the associated estimated interference may be removed from the input blended seismic data in (a).
i. Portions (b) to (e) may be iteratively repeated by applying other sets of prior information designed to enhances sparsity of different modes of seismic data such as reflection and refraction in the transformed domain.
j. The sparse inversion may be solved to estimate the coherent signal from the residual without using any prior technique to deblend seismic modes that does not obey any apriori known characteristics.
k Portions (b)-(g) may be repeated (e.g., many times) until the data is deblended adequately using different prior information.

The sparse inversion may be applied to energetic directions/dips/slownesses to reduce the deblending computational burden. The seismic data may include pressure and particle motion measurements. The seismic data may include a previous survey or surveys. The following may occur at each iteration of the multistage source separation process:
a The set of priors may enhance the sparsity of the signal of interest buried beneath the high-energy interference noise in the transformed domain and exhibit stronger coherency, while the interference signal becomes more incoherent.
b) The set of prior information can include noise attenuation of the blended data.
c) The set of prior information can include the different frequency bandwidth of events.
d) The set of prior information can include the timing information of the signal and interference.
e) A mute may be applied to the parts of the seismic data where the mode of interest of the seismic data does not exist.
f) The set of prior information can include the velocity model information of seismic data.
g) The prior information can be moveout of different modes in the seismic data.
h) The modes of the seismic data include the direct arrival, reflection, refraction, diffractions, ground roll, shear noise, and/or mudroll.
i) The sparse inversion may be solved by either the use of iterative shrinkage solvers or another advanced variant of it.
j) The thresholding value λ may be either fixed across the full spectrum of the data or different within a frequency band or varies monochromatically.
k) The thresholding schedule λ(αᵢ) may be either fixed across the full spectrum of the data or different within a frequency band or varies monochromatically.
l) The sparse inversion may stop by using the energy of the explained part as a stopping criterion
m) The transformed domain can be the Fourier, Radon, Curvelet, and/or Wavelet domain.
n) The method may stop automatically when the energy of the difference between the blended input data and the blending of the estimated unblended data is less than a predetermined threshold.
o) Adaptive subtraction may be used to remove the estimated part and the associated estimated interference from the input blended seismic data.
p) Rank-minimization may be used instead of sparsity promotion to exploit the transform domain structure.

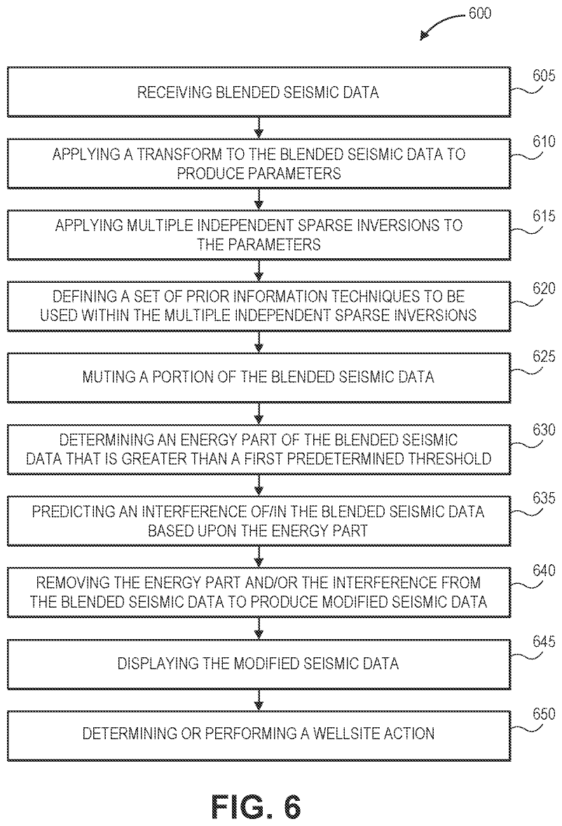

FIG. 6 illustrates a flowchart of a method 600 for processing (e.g., deblending) seismic data, according to an embodiment. An illustrative order of the method 600 is provided below; however, one or more portions of the method 600 may be performed in a different order, combined, repeated, or omitted. At least a portion of the method 600 may be performed by the computing system 700 (described below).

The method 600 may include receiving blended seismic data, as at 605. The blended seismic data may be received from one or more (e.g., a plurality of) seismic sources. The blended seismic data may include results from a current seismic survey or a previous seismic survey. The blended seismic data may include pressure measurements and/or particle motion measurements.

The method 600 may also include applying a transform to the blended seismic data, as at 610. The transform may decompose the blended seismic data into one or more different parameters. The parameters may be or include directions, dips, slownesses, or a combination thereof.

The method 600 may also include applying one or more (e.g., multiple) independent sparse inversions to the different parameters, as at 615. The independent sparse inversions may include algorithms such as the Fast Iterative Soft Thresholding Solver (FISTA) to separate the sources. More particularly, at each iteration, the current estimate of the separated signal may be blended with timing information to obtain the explained portion of the blended data (i.e., the signal estimate plus the blended noise obtained from that estimate). This explained portion may then be subtracted from the blended data to obtain the unexplained portion. This unexplained portion may then be added to the current estimate before being transformed into a sparsity-promoting domain, where it may be thresholded using a specifically-designed threshold. The thresholded data may then be transformed back to obtain the next estimate of the source-separated signal. The threshold may be designed to decrease at a fixed step in each iteration to increase the amount of signal obtained at each iteration.

The method 600 may also include defining one or more (e.g., a set of) prior information techniques to be used within the one or more (e.g., multiple) independent sparse inversions, as at 620. This may occur before or after the independent sparse inversions are applied. The set of prior information techniques may enhance a signal of interest in the blended seismic data (e.g., at the different parameters). More particularly, the set of prior information techniques may enhance a mode of the signal of interest (e.g., at the different parameters). For example, the set of prior information techniques may enhance a sparsity of the mode of the signal of interest (e.g., at the different parameters). The set of prior information techniques may cause interference in the blended seismic data to become more incoherent.

In an embodiment, the prior may be or include part of the sparse inversion itself. The prior information may be defined first and then used at each iteration of the sparse inversion. More particularly, at each iteration, the current estimate of the separated signal may be blended with timing information to obtain the explained portion of the blended data (i.e., the signal estimate plus the blended noise obtained from that estimate). This explained portion may then be subtracted from the blended data to obtain the unexplained portion. This unexplained portion may then be added to the current estimate, and prior information may be included at this stage before it is transformed into a sparsity-promoting domain, where it may be thresholded using a specifically-designed threshold. The thresholded data may then be transformed back to obtain the next estimate of the source-separated signal. The threshold may be designed to decrease at a fixed step in each iteration to increase the amount of signal obtained at each iteration. Multiple parallel blocks of sparse inversion, within each a similar or different set of priors, can be used.

The set of prior information techniques may include defining a multi-dimensional domain where the mode is sparse (e.g., sparser than a predetermined sparsity threshold), and then applying a multi-dimensional transform to transform the blended seismic data into the multi-dimensional domain. The set of prior information techniques may also or instead include attenuating noise in the blended seismic data. The set of prior information techniques may also or instead include filtering one or more frequencies in the blended seismic data. The set of prior information techniques may also or instead include applying timing information to enhance the sparsity of the mode of the signal of interest. The set of prior information techniques may also or instead include a moveout of different modes of the blended seismic data based on a predefined velocity model. The modes may include direct arrival, reflection, refraction, diffraction, ground roll, shear noise, mudroll, or a combination thereof.

The method 600 may also include muting a portion of the blended seismic data where the mode of the signal interest does not exist (or exists below a predetermined mode threshold), as at 625. The muted portion may be a frequency band, a wavelength band, an amplitude band, or the like.

The method 600 may also include determining an energy part of the blended seismic data that is greater than a first predetermined threshold, as at 630. The energy part may include the portion of the data where the signal amplitude is high (e.g., above a predetermined threshold) at the multi-dimensional transform domain. The energy part may be determined based at least partially upon the one or more (e.g., multiple) independent sparse inversions and/or the set of prior information techniques. The one or more (e.g., multiple) independent sparse inversions may stop based at least partially upon a value of the energy part (e.g., being greater than or less than the first predetermined threshold).

The method 600 may also include predicting an interference of/in the blended seismic data based at least partially upon the energy part, as at 635. The interference may include when signals from other sources are reflected and/or refracted in a way that they overlap with the signal of interest. This may happen when the signals from other sources arrive at the same time of the signal of interest, causing disruptions in the observation of the signal of interest.

The method 600 may also include removing the energy part and/or the interference from the blended seismic data to produce modified seismic data, as at 640.

The method 600 may also include displaying the modified seismic data, as at 645. This may also or instead include displaying the blended seismic data, the transform, the parameters (e.g., directions, dips, and/or slownesses), the sparse inversions, the set of prior information techniques, the energy part, the interference, or a combination thereof.

The method 600 may also include determining or performing a wellsite action, as at 650. The wellsite action may be determined or performed based at least partially upon the modified seismic data. The wellsite action may also or instead be determined or performed based at least partially upon the blended seismic data, the transform, the parameters (e.g., directions, dips, and/or slownesses), the sparse inversions, the set of prior information techniques, the energy part, the interference, the modified seismic data or a combination thereof. In one embodiment, performing the wellsite action may include generating and/or transmitting a control signal (e.g., using the computing system 700) which instructs or causes a physical action to take place at the wellsite. In another embodiment, performing the wellsite action may include physically performing the action (e.g., either manually or automatically). Illustrative physical actions may include, but are not limited to, selecting a location to drill a wellbore, determining risks while drilling the wellbore, drilling the wellbore, varying a trajectory of the wellbore, varying a weight on the bit of a downhole tool that is drilling the wellbore, varying a composition or flow rate of a drilling fluid that is introduced into the wellbore, or a combination thereof.

At least a portion of the method 600 may be iterative. The iterations may stop in response to a difference between the blended seismic data and the modified seismic data becoming less than a second predetermined threshold.

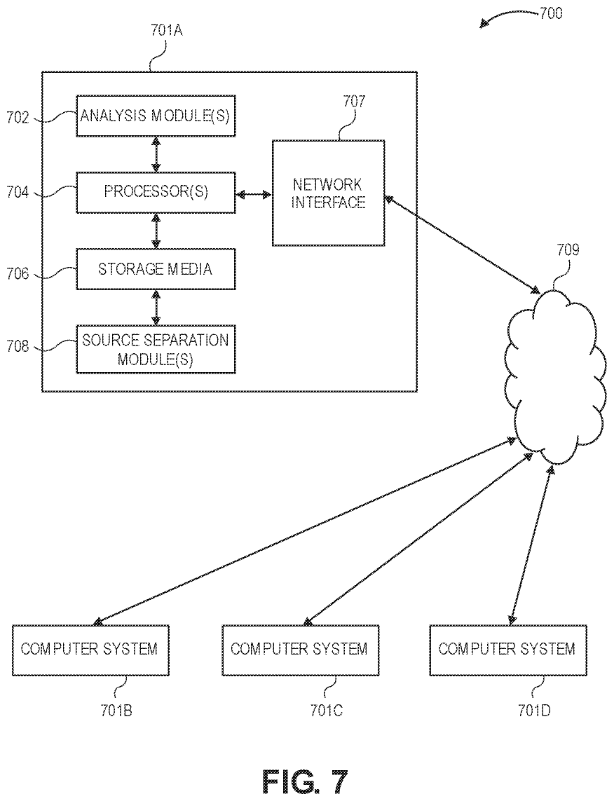

In some embodiments, any of the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis module(s) 702 configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor can include a microprocessor, microcontroller, processor module or subsystem, programmable integrated circuit, programmable gate array, or another control or computing device.

The storage media 706 can be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 700 contains one or more source separation (e.g., deblending) module(s) 708 that may perform at least a portion of one or more of the method(s) described above. It should be appreciated that computing system 700 is only one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of embodiments of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subterranean three-dimensional geologic formation under consideration.

The following clauses set out some embodiments of the invention:
Clause 1: A method for processing seismic data, the method comprising: receiving blended seismic data from one or more seismic sources; applying a transform to the blended seismic data to decompose the blended seismic data into different parameters; applying one or more independent sparse inversions to the different parameters; defining a set of prior information techniques to be used within the one or more independent sparse inversions; determining an energy part of the blended seismic data that is greater than a first predetermined threshold based at least partially upon the multiple independent sparse inversions, the set of prior information techniques, or both; and removing the energy part from the blended seismic data to produce modified seismic data.
Clause 2: The method of clause 1, wherein the blended seismic data comprises pressure measurements, particle motion measurements, or both.
Clause 3: The method of clause 1 or 2, wherein the parameters comprise directions, dips, slownesses, or a combination thereof.
Clause 4: The method of any one of clauses 1-3, wherein the set of prior information techniques is configured to enhance a signal of interest in the blended seismic data.
Clause 5: The method of any one of clauses 1-4, wherein the set of prior information techniques is configured to enhance a mode of a signal of interest in the blended seismic data at one or more of the different parameters.
Clause 6: The method of any one of clauses 1-5, wherein the set of prior information techniques is configured to enhance a sparsity of a mode of a signal of interest in the blended seismic data at the different parameters.
Clause 7: The method of any one of clauses 1-6, further comprising: predicting an interference of the blended seismic data based at least partially upon the energy part; and removing the energy part and the interference from the blended seismic data to produce the modified seismic data.
Clause 8: The method of any one of clauses 1-7, wherein at least a portion of the method is iterative, and the iterations stop in response to a difference between the blended seismic data and the modified seismic data becoming less than a second predetermined threshold.
Clause 9: The method of any one of clauses 1-8, further comprising displaying the modified seismic data.
Clause 10: The method of any one of clauses 1-9, further comprising performing a wellsite action based upon the modified seismic data.
Clause 11: A computing system comprising: one or more processors; and a memory system comprising one or more non-transitory computer-readable media storing instructions that, when executed by at least one of the one or more processors, cause the computing system to perform operations, the operations comprising: receiving blended seismic data from a plurality of seismic sources, the blended seismic data comprises pressure measurements, particle motion measurements, or both; applying a transform to the blended seismic data to decompose the blended seismic data into different parameters, the parameters comprise directions, dips, slownesses, or a combination thereof; applying multiple independent sparse inversions to the different parameters; defining a set of prior information techniques to be used within the multiple independent sparse inversions, the set of prior information techniques is configured to enhance a sparsity of a mode of a signal of interest in the blended seismic data at the different parameters; determining an energy part of the blended seismic data that is greater than a first predetermined threshold based at least partially upon the multiple independent sparse inversions and the set of prior information techniques; predicting an interference of the blended seismic data based at least partially upon the energy part; and removing the energy part and the interference from the blended seismic data to produce modified seismic data.
Clause 12: The computing system of clause 11, wherein the set of prior information techniques causes interference in the blended seismic data to become more incoherent.
Clause 13: The computing system of clause 11 or 12, wherein the multiple independent sparse inversions stop based at least partially upon a value of the energy part.
Clause 14: The computing system of any one of clauses 11-13, wherein the operations further comprise muting a portion of the blended seismic data where the mode of the signal interest does not exist.
Clause 15: The computing system of any one of clauses 11-14, wherein the operations further comprise displaying the modified seismic data.
Clause 16: A non-transitory computer-readable medium storing instructions that, when executed by at least one processor of a computing system, cause the computing system to perform operations, the operations comprising: receiving blended seismic data from a plurality of seismic sources, the blended seismic data comprises pressure measurements and particle motion measurements; applying a transform to the blended seismic data to decompose the blended seismic data into different directions, dips, and slownesses; applying multiple independent sparse inversions to the different directions, dips, and slownesses; defining a set of prior information techniques to be used within the multiple independent sparse inversions, the set of prior information techniques is configured to enhance a sparsity of a mode of a signal of interest in the blended seismic data at the different directions, dips, and slownesses, and the set of prior information techniques causes interference in the blended seismic data to become more incoherent; determining an energy part of the blended seismic data that is greater than a first predetermined threshold based at least partially upon the multiple independent sparse inversions and the set of prior information techniques, the multiple independent sparse inversions stop based at least partially upon a value of the energy part; predicting an interference of the blended seismic data based at least partially upon the energy part; removing the energy part and the interference from the blended seismic data to produce modified seismic data; and displaying the modified seismic data.
Clause 17: The non-transitory computer-readable medium of clause 16, wherein the set of prior information techniques comprises: defining a multi-dimensional domain where the mode is sparser than a second predetermined threshold; and applying a multi-dimensional transform to the blended seismic data to transform blended seismic data into the multi-dimensional domain.
Clause 18: The non-transitory computer-readable medium of clause 16 or 17, wherein the set of prior information techniques comprises applying timing information to enhance the sparsity of the mode of the signal of interest.
Clause 19: The non-transitory computer-readable medium of any one of clauses 16-18, wherein at least a portion of the operations is iterative, and the iterations stop in response to a difference between the blended seismic data and the modified seismic data becoming less than a second predetermined threshold.
Clause 20: The non-transitory computer-readable medium of any one of clauses 16-19, wherein the operations further comprise generating a control signal based at least partially upon the modified seismic data, and the control signal is configured to control equipment at the wellsite.

The foregoing description, for purpose of explanation, has been described with reference to specific embodiments. However, the illustrative discussions above are not intended to be exhaustive or to limit the embodiments of the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for processing seismic data, the method comprising:
receiving blended seismic data from one or more seismic sources;
applying a transform to the blended seismic data to decompose the blended seismic data into different parameters;
applying one or more independent sparse inversions to the different parameters;
defining a set of prior information techniques to be used within the one or more independent sparse inversions;
determining an energy part of the blended seismic data that is greater than a first predetermined threshold based at least partially upon the multiple independent sparse inversions, the set of prior information techniques, or both; and
removing the energy part from the blended seismic data to produce modified seismic data.

2. The method of claim 1, wherein the blended seismic data includes pressure measurements, particle motion measurements, or both.

3. The method of claim 1, wherein the parameters include directions, dips, slownesses, or a combination thereof.

4. The method of claim 1, wherein the set of prior information techniques is configured to enhance a signal of interest in the blended seismic data.

5. The method of claim 1, wherein the set of prior information techniques is configured to enhance a mode of a signal of interest in the blended seismic data at one or more of the different parameters.

6. The method of claim 1, wherein the set of prior information techniques is configured to enhance a sparsity of a mode of a signal of interest in the blended seismic data at the different parameters.

7. The method of claim 1, comprising:
predicting an interference of the blended seismic data based at least partially upon the energy part; and
removing the energy part and the interference from the blended seismic data to produce the modified seismic data.

8. The method of claim 1, wherein at least a portion of the method is iterative, and the iterations stop in response to a difference between the blended seismic data and the modified seismic data becoming less than a second predetermined threshold.

9. The method of claim 1, comprising displaying the modified seismic data.

10. The method of claim 1, comprising performing a wellsite action based upon the modified seismic data.

11. A computing system comprising:
one or more processors; and
a memory system including one or more non-transitory computer-readable media storing instructions that, when executed by at least one of the one or more processors, cause the computing system to perform operations, the operations including:
receiving blended seismic data from a plurality of seismic sources, the blended seismic data includes pressure measurements, particle motion measurements, or both;
applying a transform to the blended seismic data to decompose the blended seismic data into different parameters, the parameters include directions, dips, slownesses, or a combination thereof;
applying multiple independent sparse inversions to the different parameters;
defining a set of prior information techniques to be used within the multiple independent sparse inversions, the set of prior information techniques is configured to enhance a sparsity of a mode of a signal of interest in the blended seismic data at the different parameters;
determining an energy part of the blended seismic data that is greater than a first predetermined threshold based at least partially upon the multiple independent sparse inversions and the set of prior information techniques;
predicting an interference of the blended seismic data based at least partially upon the energy part; and
removing the energy part and the interference from the blended seismic data to produce modified seismic data.

12. The computing system of claim 11, wherein the set of prior information techniques causes interference in the blended seismic data to become more incoherent.

13. The computing system of claim 11, wherein the multiple independent sparse inversions stop based at least partially upon a value of the energy part.

14. The computing system of claim 11, wherein the operations include muting a portion of the blended seismic data where the mode of the signal interest does not exist.

15. The computing system of claim 11, wherein the operations include displaying the modified seismic data.

16. A non-transitory computer-readable medium storing instructions that, when executed by at least one processor of a computing system, cause the computing system to perform operations, the operations comprising:
receiving blended seismic data from a plurality of seismic sources, the blended seismic data includes pressure measurements and particle motion measurements;
applying a transform to the blended seismic data to decompose the blended seismic data into different directions, dips, and slownesses;
applying multiple independent sparse inversions to the different directions, dips, and slownesses;
defining a set of prior information techniques to be used within the multiple independent sparse inversions, the set of prior information techniques is configured to enhance a sparsity of a mode of a signal of interest in the blended seismic data at the different directions, dips, and slownesses, and the set of prior information techniques causes interference in the blended seismic data to become more incoherent;
determining an energy part of the blended seismic data that is greater than a first predetermined threshold based at least partially upon the multiple independent sparse inversions and the set of prior information techniques, the multiple independent sparse inversions stop based at least partially upon a value of the energy part;
predicting an interference of the blended seismic data based at least partially upon the energy part;
removing the energy part and the interference from the blended seismic data to produce modified seismic data; and
displaying the modified seismic data.

17. The non-transitory computer-readable medium of claim 16, wherein the set of prior information techniques includes:
defining a multi-dimensional domain where the mode is sparser than a second predetermined threshold; and
applying a multi-dimensional transform to the blended seismic data to transform blended seismic data into the multi-dimensional domain.

18. The non-transitory computer-readable medium of claim 16, wherein the set of prior information techniques includes applying timing information to enhance the sparsity of the mode of the signal of interest.

19. The non-transitory computer-readable medium of claim 16, wherein at least a portion of the operations is iterative, and the iterations stop in response to a difference between the blended seismic data and the modified seismic data becoming less than a second predetermined threshold.

20. The non-transitory computer-readable medium of claim 16, wherein the operations further include generating a control signal based at least partially upon the modified seismic data, and the control signal is configured to control equipment at the wellsite.
